(19) United States
(12) Patent Application Publication
(10) Pub. No.: US 2009/0270772 A1
(43) Pub. Date: Oct. 29, 2009

(54) Face Massage Roller

(75) Inventor: Fumio Kurosu, Kanagawa-ken (JP)

Correspondence Address: Konomi Takeshita, Eight Penn Center, Suite 1300,, 1628 John F. Kennedy Blvd., Philadelphia, PA, 19103, US

(73) Assignee: HOMARE CO., LTD., Chiba-ken (JP)

(21) Appl. No.: 12/426,657

(22) Filed: Apr. 20, 2009

(30) Foreign Application Priority Data
Apr. 28, 2008 (JP) 2008-002755

(51) Int. Cl. A61H 1/00; A61H 15/00

(52) U.S. Cl. 601/19; 601/120

(57) ABSTRACT

The purpose of the present device is to provide a face massage roller, which has a means to fix the magnets and the ceramic part(s) firmly without using an adhesive, which can produce a good massaging performance for a long term, and which reduces the burden due to defects generated after the selling of the products. This problem is solved by a face massage roller, having a presser member, lying between a back lid and a frame part, in which two or more rollers are supported by shafts, and being fixed to the back lid by welding, in such a way that a far-infrared ray radiation material part is between the inner side surface of the back lid and the presser member, under the two or more rollers, and the presser member retains the far-infrared ray radiation material part on the inner side surface of the back lid by welding fixation.

### CROSS REFERENCE TO RELATED APPLICATIONS

This application claims priority under 35 U.S.C. 119 based upon Japanese Utility Model Application No. 2008-002755, filed on Apr. 28, 2008. The entire disclosure of the aforesaid application is incorporated herein by reference.

### BACKGROUND OF THE INVENTION

1. Field of the Invention

The present device relates to a massage roller for performing a massage on the face by holding it by hand.

2. Description of the Related Art

A massage roller for, easily and at anytime users want, performing a massage on one's face by holding it by hand is known. Such a massage roller has a long rod shaped handle and two or more rollers, which are installed in a rotatable way at one end of the handle, and the rollers are moved back and forth, holding them to the face.

The massaging effect, such as the improvement of the blood circulation and the canceling of swelling, is achieved by the above-mentioned massaging device, by promoting the hypodermic blood stream and lymph flow, while giving moderate stimulation to the skin, through some friction and pressing on the face caused by a plurality of rollers (e.g., refer to Japanese Utility Model Registration No. 3087105).

In the above-mentioned conventional massaging device, the constitution that a back lid, which covers the opening(s) of a frame part, is installed on the rear side of the frame part, which supports rollers by shafts, and a magnet and a ceramic part are stored in the space, which is formed between the rollers and the back lid, is employed. In this case, the magnet and the ceramic part are fixed by an adhesive agent on the inner surface of the back lid so that the magnet and the ceramic do not move.

However, in the case where the far-infrared ray radiation material part is installed, it could happen that the magnet and the ceramic drop from the location to which they are fixed, because the adhesive agent for fixing them to the back lid etc. becomes loose or deteriorated with the lapse of time. It is speculated that this is due to the fact that highly polymerized compounds, which compose adhesive agents, absorb far-infrared rays well.

The above-mentioned magnet and ceramic, which have fallen, damage the constituent members mutually by hitting the rollers, and disturb good massaging performance. Moreover, since this is taken as defects generated under the usual state of use, additional costs for recalling, repairing or exchange etc. after the selling of the products, and time consuming managements come into necessity.

Thus, a face massage roller, which has a means to fix the installed magnets and the ceramics firmly without using an adhesive, and which can produce a good massaging performance for a long term, and which reduces the burden due to defects generated after the selling of the products is highly desired.

### SUMMARY OF THE INVENTION

To solve the above mentioned problem, according to the present invention there is provided a face massage roller having a long rod shaped handle part, a frame part, which is formed at the tip of the handle part in one piece with the handle part, two or more cylindrical rollers, which are supported by shafts in a rotatable state in the frame part, a back lid, which is installed in the frame part, so that the opening of the frame is covered and which forms a space between the two or more rollers and the back lid, and a far-infrared ray radiation material part(s), which is stored and installed in the space on the inner side of the back lid, wherein the face massage roller has a presser member, which lies between the back lid and the frame part, the presser member being fixed to the back lid by welding, in a state that the far-infrared ray radiation material part(s) is between the inner side surface of the back lid and the presser member, under the two or more rollers, and the presser member retains the far-infrared rays radiation material part(s) on the inner side surface of the back lid by welding fixation.

In another aspect of the invention, the presser member has wall part(s), which partition the space between the back lid and the presser member into two or more compartments, and the wall part(s) are formed in one piece with the presser member.

According to a further aspect of the invention, the presser member has opening(s), which expose the surface of the far-infrared ray radiation material part(s) toward the direction of the rollers.

In the face massage roller, according to the present device, the presser member retains and fixes firmly, without adhesives, the far-infrared ray radiation material, which is between the inner side of the back lid and the presser member, under the two or more rollers, and the presser member lies between the frame part, in which the cylindrical rollers are supported by shafts in a rotatable state, and the back lid, which is installed in a manner that the opening of the frame is covered, and the presser member is fixed to the back lid by welding. Thus, unlike conventional massage rollers, it does not happen that far-infrared ray radiation material, which falls from the fixed location, interferes with the rollers. As a result, the effects achieved are: a good massaging performance is obtained for a long term, the costs necessary for recalling, repairing or exchange etc. after the selling of the products are greatly reduced, and so are defects requiring time consuming management.

### BRIEF DESCRIPTION OF THE DRAWINGS

FIG. 1 is a schematic view, showing the whole constitution of the face massage roller according to one embodiment of the present device. (a) is a summarized perspective view showing member components of the present face massage roller before assembly. (b) is a side view of the present face massage roller after assembly.

FIG. 2 is a partly sectioned perspective view, which shows the structure of the assembled head part of the face massage roller.

FIG. 3 is a side sectional view of the assembled head part.

### DETAILED DESCRIPTION OF THE PREFERRED EMBODIMENTS

In the face massage roller, according to the present device, each of two or more cylindrical rollers is supported by a shaft in a rotatable state in a frame part, which is formed at the tip of a handle part in one piece with the handle part. In the face massage roller, according to the present device, a far-infrared ray radiation material part(s) is stored and installed in the space formed between the two or more rollers and a back lid, which is installed in the frame part, so that the opening of the frame is covered. The face massage roller has a presser member, which lies between the back lid and the frame part, and which is fixed to the back lid by welding, in such a way that the far-infrared ray radiation material part(s) is between the inner side of the back lid and the presser member, under the two or more rollers; and the presser member retains the far-infrared rays radiation material part(s) on the inner side surface of the back lid by welding fixation.

Thus, in the face massage roller, according to the present device, due to the presser member being fixed to the back lid by welding, the far-infrared ray radiation material part(s) is firmly retained and fixed between the inner side of the back lid and the presser member. Therefore, unlike conventional massage rollers, it does not happen that the far-infrared ray radiation material part(s), which falls from the fixed location, interferes with the rollers, and so this makes it possible to perform a good massaging operation for a long term. Furthermore, the costs necessary for recalling, repairing or exchange etc. after the selling of the products, and defects requiring time consuming managements are greatly reduced.

The number of pieces of the far-infrared ray radiation material installed in the massage roller is not limited to one, and may be two or more. Furthermore, the far-infrared ray radiation material part(s) may be installed together with a magnet. The presser member may have wall part(s), which partition the space between the back lid and the presser member into two or more compartments, and which are formed in one piece with the presser member. In this case, each of the far-infrared ray radiation material part and magnet can be stored and retained in each partitioned compartment independently from each other, avoiding their mutual collision. Each of the far-infrared ray radiation material parts, which are stored in each partitioned compartment, can be well retained in the compartments, as far as the size of said part is smaller than the capacity of the compartment. Thus, the sizes of the parts may be uneven, and it is not necessary to adjust the sizes of the parts with extreme precision according to the storage spaces. This makes the product manufacturing process easier.

The presser member, in the present device, does not have to hold the far-infrared ray radiation material part and the magnet, which are held between the inner side of the back lid and the presser member, by covering their whole surface. They can be held well by covering their surface partially with the presser member. Thus, it is possible to form an opening(s), which exposes the surface of the far-infrared ray radiation material toward the direction of the rollers, on the presser member, while keeping the necessary surface area of the far-infrared rays radiation material part and the magnet held in place. By forming such an opening(s), far-infrared rays and magnetic waves from the magnet can be more efficiently radiated, and it makes the improvement of the massaging effect more certain.

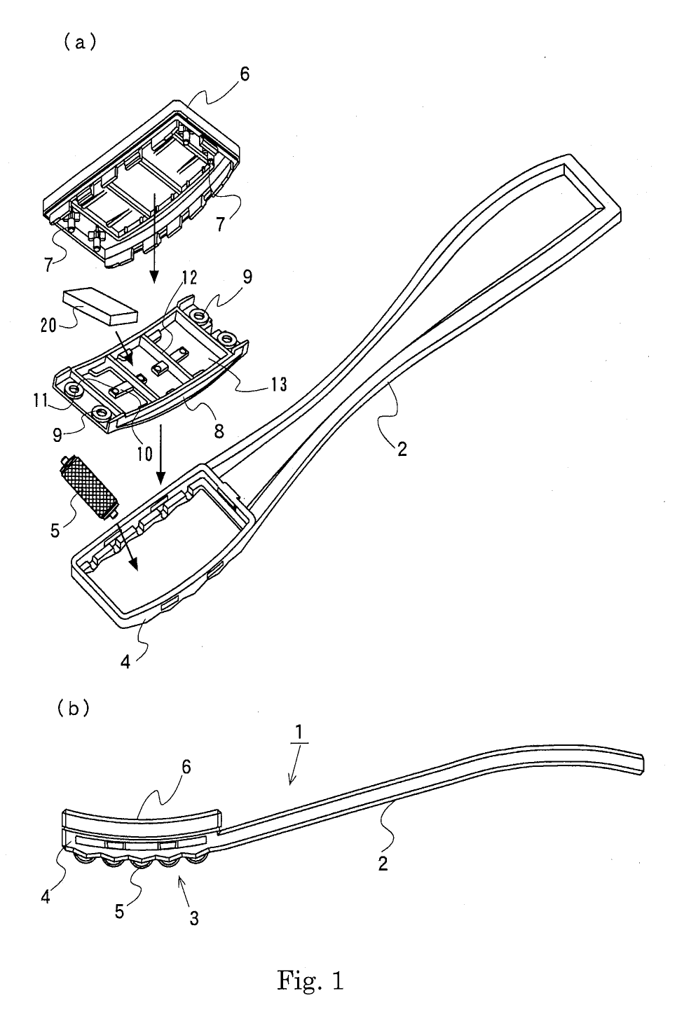

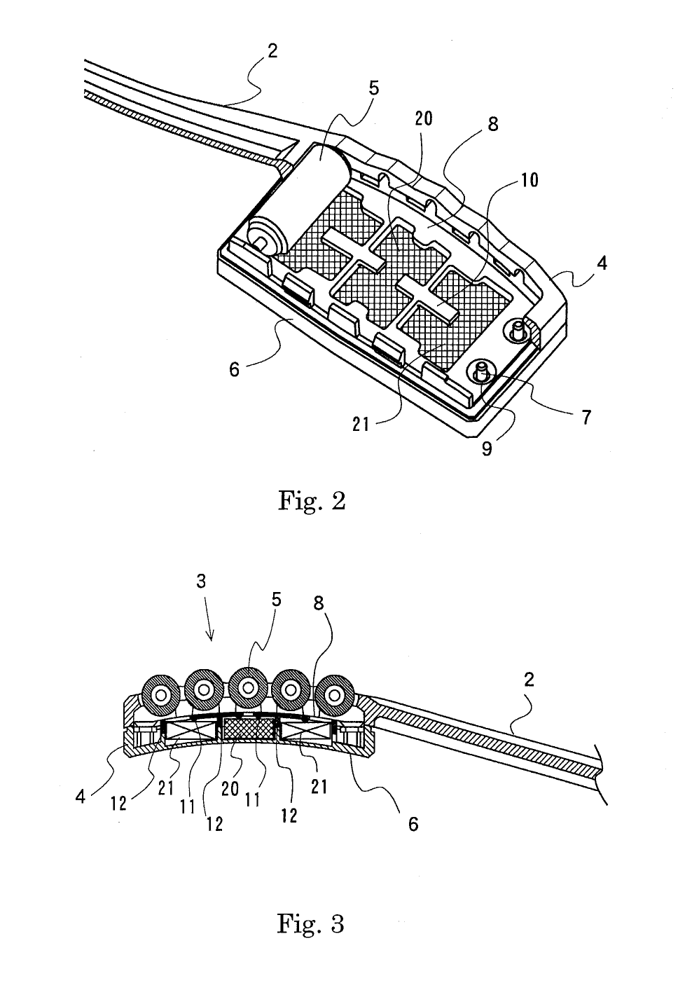

As an embodiment of the present device, FIGS. 1 to 3 show a face massage roller, in which one far-infrared ray radiation ceramic part and two magnets are installed. FIG. 1 is a schematic view, which shows the whole constitution of the face massage roller according to this embodiment, and (a) is a summarized perspective view, which shows member components of the present face massage roller before assembly. (b) is a side view of the present face massage roller after assembly. FIG. 2 is a partly sectioned perspective view, which shows the structure of the assembled head part of the face massage roller. In FIG. 2, to show the lower part of the face massage roller, observed from the surface side, the rollers are not shown for convenience. FIG. 3 is a side sectional view of the assembled head part.

The present face massage roller 1 is mainly composed of a long rod shaped handle part 2 and a head part 3 for massaging, which is installed at the tip of the handle part. In the head part 3, two or more cylindrical rollers 5 are supported by shafts in a rotatable state in a frame part 4, which is formed in one piece with the handle part 2.

The head part 3, in the present embodiment, has a back lid 6, which is installed in the frame part 4, so that the opening of the frame is covered, and also has a presser member 8, which forms a space to store the far-infrared ray radiation ceramic part 20 and the magnets 21, between the back lid 6 and the presser member 8, under the two or more rollers 5.

This presser member 8 is fixed to the back lid 6 by welding, in such a way that the ceramic part 20 and the magnets 21 are between the inner side surface of the back lid 6 and the presser member 8, and the presser member 8 retains the ceramic part 20 and the magnets 21 on the inner side surface of the back lid 6 in this fixed state by welding.

There is no restriction for the constitution of the fixed part(s) by welding between two members. For example, fitting parts, which can be welded, may be formed in the back lid 6 and the presser member 8. These fitting parts should be formed in the area, which does not affect the fitting parts between the back lid 6 and the frame part 4. In the present embodiment, the fitting parts for welding fixation are composed of caulking projections 7, which are formed on both end parts on the inner side of the back lid 6 in one piece with the back lid 6, and caulking cylinder parts 9, which are formed at the corresponding locations on both end parts of the presser member 8 in one piece with the presser member 8, and in which each caulking projection 7 is put.

Therefore, the fixing and retaining state is achieved, in that the presser member 8 is fixed to the back lid 6 by welding and the ceramic part 20 and the magnets 21 are pressed on the inner side surface of the back lid 6, by welding the fitting parts in such a way that the caulking projections 7 are put in the caulking cylinder parts 9, while putting the ceramic part 20 and the magnets 21 between the back lid 6 and the presser member 8.

In the present embodiment, the presser member 8 has wall parts 12, which partition the above-mentioned storing space between the back lid 6 and the presser member 8 into three compartments, at regular intervals. Each of the following three, one ceramic part 20 and two magnets 21, is stored in a different compartment. By this constitution, each of components, the ceramic part 20 and magnets 21, is stored and retained in each compartment independently from each other, without their mutual collision.

Openings 13, which make it possible to expose the surface of the ceramic part 20 and each magnet 21 toward the direction of the rollers 5, were formed on the presser member 8, so that far-infrared rays and magnetic waves can be more efficiently radiated. Here, the presser part 10 occupies the least necessary area for retaining the ceramic part 20 and the magnets 21 by pressing them to the direction of the back lid 6, to make the exposed area of the ceramic part 20 and the magnets 21 as large as possible.

In the face massage roller of the present embodiment, the frame part 4 gently curves to protrude in the upper direction, and each of the rollers 5 is supported by shafts along this curve, so that the surface of the head part 3 can come in better contact with the uneven surface of a face. Therefore, the presser member 8 and the back lid 6 also curve, corresponding to the frame part 4.

In this case, the surface of the plate shaped ceramic part 20 and magnets 21 cannot easily fit with the gently curved counter surface of the presser member 8. Thus, two or more presser projections 11 were installed on the under surface of the presser part 10. By those projections 11, both the ceramic part 20 and each magnet 21 are sufficiently pressed, even if the presser member 8 curves.

The face massage roller according to the present embodiment, which has the above-mentioned constitution, solves the problems of conventional massage rollers, namely, unlike fixation by adhesives, the retaining and fixation state of the ceramic part 20 and magnets 21 does not become loose with the lapsing of time, and thus the defects due to the falling of the magnets and the ceramic part are hardly caused. This makes it possible to conduct a good massaging performance for a long term. Moreover, the costs necessary for recalling, repairing or exchange etc. after the selling of the products, and time consuming management, due to defects caused by the falling of the magnet and the ceramic, are no longer necessary.

What is claimed is:

1. A face massage roller having
a long rod shaped handle part;
a frame part, which is formed at a tip of said handle part in one piece with said handle part;
two or more cylindrical rollers, which are supported by shafts in a rotatable state in said frame part;
a back lid, which is installed in said frame part, so that the opening of said frame is covered and which forms a space between said two or more rollers and said back lid; and
a far-infrared ray radiation material part(s), which is stored and installed in said space on an inner side of said back lid, comprising:
a presser member which lies between said back lid and said frame part,
said presser member being fixed to said back lid by welding, in such a way that said far-infrared ray radiation material part(s) is between an inner side surface of said back lid and said presser member, under said two or more rollers, and
said presser member retains said far-infrared ray radiation material part(s) on the inner side surface of said back lid by welding fixation.

2. The face massage roller according to claim 1, wherein said presser member has wall part(s), which partition a space between said back lid and said presser member into two or more compartments, and said wall part(s) are formed in one piece with said presser member.

3. The face massage roller according to claim 1, wherein said presser member has opening(s), which expose a surface of said far-infrared ray radiation material part(s) toward a direction of said rollers.
